(19) United States
(12) Patent Application Publication
(10) Pub. No.: US 2016/0304104 A1
(43) Pub. Date: Oct. 20, 2016

(54) SYSTEM FOR INSPECTING RAIL WITH PHASED ARRAY ULTRASONICS

(71) Applicant: Transportation Technology Center, Inc., Pueblo, CO (US)

(72) Inventors: Matthew Ward Witte, Tecumseh, MI (US); Semih Kalay, Colorado Springs, CO (US); Lucas Rahe Welander, Manzanola, CO (US); Paul Christopher Boulware, Columbus, OH (US); Roger Lynn Spencer, Ashville, OH (US)

(73) Assignee: Transportation Technology Center, Inc., Pueblo, CO (US)

(21) Appl. No.: 15/099,387

(22) Filed: Apr. 14, 2016

Related U.S. Application Data
(60) Provisional application No. 62/148,289, filed on Apr. 16, 2015.

(51) Int. Cl. B61K 9/10; G01N 29/28; G01N 29/22; G01N 29/04

(52) U.S. Cl. CPC B61K 9/10; G01N 29/04; G01N 29/28; G01N 29/225

(57) ABSTRACT

A system for inspecting railroad rail using phased array ultrasonic technology measures the time of flight of ultrasonic signals at locations across the rail head to determine the wear profile of the rail. The rail wear profile is then used to adjust the focal laws of the phased array ultrasonic probes to dynamically compensate for changes in the rail profile as the inspection vehicle moves along the rails.

### RELATED APPLICATION

The present application is based on and claims priority to the Applicant's U.S. Provisional Patent Application No. 62/148,289, entitled “System for Inspecting Rail with Phased Array Ultrasonics,” filed on Apr. 16, 2015.

### BACKGROUND OF THE INVENTION

1. Field of the Invention

The present invention relates generally to the inspection of railway rail and more particularly to the inspection of in-situ railway rail from a moving vehicle on the track. More specifically, the present invention is in the field of phased array ultrasonic non-destructive evaluation.

2. Statement of the Problem

Ultrasonic nondestructive testing is a common inspection technology for detecting flaws in solid materials. Present-day ultrasonic systems for rail inspection consist of an inspection vehicle, at least one rolling search unit (RSU) per rail, multiple single-angle transducers, an ultrasonics controller and acquisition unit, and some means of processing, displaying, and storing the acquired data. The RSU is liquid-filled and pressurized so it can roll atop the rail head (FIGS. 1 and 2). It is mounted to the inspection vehicle mechanically such that as the inspection vehicle moves along the rails, the RSU rolls along with it. Single-angle transducers are mounted within the RSU at selected positions and orientations with respect to the rail.

Because defects in rail manifest themselves in different locations and orientations within the rail head, web, and base, traditional RSU configurations incorporate a multitude of single-angle ultrasonic transducers aimed at these locations. Each transducer can target a different defect-prone location within the rail by being placed at a unique location and orientation within the RSU and inspecting only at that unique angle. A typical inspection configuration may consist of multiple RSUs each with four to seven transducers. While traditional configurations have shown some success in rail defect detection, they are limited in terms of adaptability to changing rail conditions. This deficiency is most obviously revealed in worn rail conditions.

The RSU rides on top of rail providing an interface for transmission of the ultrasonic energy into the rail. The ultrasonic energy is generated at the sensor interface within the RSU and emitted in a direction down towards the rail interface. The ultrasound transmits through the liquid in the RSU, the RSU membrane (typically polyurethane), through a thin liquid couplant that is applied ahead of the RSU, and into the rail. The ultrasound then reflects off of the rail geometry boundaries and returns to the receiving sensors. Inspection techniques are based on interrogation of the ultrasound signal as it returns to the sensor receptors (e.g., has the signal reflected off of any unexpected interfaces; cracks, pores, etc.).

In typical operation, each transducer fires at a given displacement interval. The ultrasonic data for each interval is acquired and buffered into a live B-scan display depicting the data as a function of travel distance and sound path. The operator visually examines each of these B-scans and identifies any abnormal indications.

While these fixed-angle configurations have shown success in rail defect detection, they are limited in terms of adaptability and resolution. From the adaptability perspective, the configuration is fixed with respect to the rail. This means that fixed angle probes will not be sensitive to anomaly defects that do not reside in a typical defect zone or that are oriented at atypical angles. If the defect is not in the inspection zone of the beam angle it will not be detected. If the defect manifests an abnormal orientation, the beam may not properly reflect off of the defect, and again, will not be detected. Additionally, if the rail profile conditions are not ideal (i.e., worn rail), the nominal angles may not be achieved. Defects that reside in typical zones may be missed when the fixed configuration angles have shifted because of the surface wear.

Traditional fixed-angle configurations also evince deficiencies in resolution and redundancy with respect to defect detection. Depending on the size and orientation of the defect, only one angle may be able to detect it, and that detection may manifest itself in as few as one frame of data (e.g., A-scan). The operator may easily miss the indication. Additionally, a typical fixed angle inspection configuration consists of incoherent angles, each inspecting a separate zone. Therefore, the correlations between the angles relating the indications are weak. A scan of angles across a defect is not possible and redundant detection of a defect is unlikely.

3. Solution to the Problem

The phased array technology employed in the present invention provides a means to address the deficiencies of traditional RSU configurations. The present invention employs a number of phased array ultrasonic probes, each made up of multiple transducing elements built into an array (e.g., matrix, linear, annular, circular, etc.) These elements can be pulsed in such a way to focus, scan, or steer the ultrasonic beam. Each phased array probe can be programmatically configured to produce variable beam angles for more detailed inspection of the rail or to compensate for changes in the rail profile due to wear. In particular, the present invention employs ultrasonic transducers mounted transverse to the rail to determine the rail head wear. A controller then adjusts the focal laws of the phased array ultrasonic probes to compensate for rail profile wear.

### SUMMARY OF THE INVENTION

The present invention provides a system for ultrasonic rail inspection that addresses the deficiencies of traditional RSU configurations by enabling an optimal configuration of phased array ultrasonic probes and focal laws to inspect railroad rail. This approach compensates for the effects of rail profile wear without introducing any external profile measurement hardware. In particular, the present system includes ultrasonic transducers extending transverse to the rail to determine the wear profile of the rail. A controller then uses the rail wear profile to adjust the focal laws of the phased array ultrasonic probes used for rail inspection to dynamically compensate for changes in the rail profile as the inspection vehicle moves along the rails.

As previously noted, traditional RSU configurations incorporate a plurality of single-angle ultrasonic transducers aimed at these locations because rail defects can manifest themselves in different locations and orientations within the rail head, web, and base. Each transducer targets a different defect-prone volume within the rail by being placed at a unique location and orientation within the RSU and inspecting only at that unique angle. In contrast to the prior art, each phased array probe in the present invention interrogates a specific portion of the rail even when the actual refracted beam angles vary because of rail wear. Where wear is present, the nominal values can be adjusted to once again cover the target rail volume. The separation of the ultrasonic probes provides an advantage in this case as each set of beam angles may be adjusted independently. For example, if wear is only detected on the gage side, adjustments may be limited to only the gage side ultrasonic probes.

The configuration of each transducer's position and orientation is determined based on nominal rail conditions. Mounting fixtures are designed and fabricated to hold each transducer in such a way that its beam angle interrogates a key defect-prone location. However, when the RSU transitions to a worn rail surface, this originally ideal angle will shift. FIGS. 4 and 5 are diagrams showing a schematic of single-angle transducers 50, 51 on nominal and worn rail profiles, respectively. This shift in the fields of view 55, 56 of the ultrasonic transducers 50, 51 is primarily due to changes in the ultrasonic refraction angle incident upon the rail surface. As the incident beam angle changes, the refracted angle within the rail will change causing the sound beam to be refracted away from its intended path. This leads to missed defects due to missing the intended target.

The present invention overcomes this deficiency by taking advantage of the unique configuration of the phased array probes. The probe elements can be pulsed in such a way to focus, scan, or steer an ultrasonic beam. The phased array probes can be programmatically configured to produce variable beam angles. This means that when rail wear is detected, the present system can electronically adjust its beam angles to compensate for the wear-induced error. The dynamic configuration of probes provides a way to sense the fluid-path distance within the RSU, which provides a direct measure of rail profile. An open-loop control system is described to consistently maintain the beam inspection path coverage over the intended zones.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified system block diagram of the present inspection system carried by a railway vehicle 12 to inspect a rail 10.

FIG. 2 is a cross-sectional side view of the rail 10 and roller search unit (RSU) 20.

FIG. 3 is a pictorial diagram showing the preferred configuration of phased array probes showing three matrix phased array (MPA) probes 32-36 and one transverse linear phased array (LPA) probe 30.

FIGS. 4 and 5 are pictorial diagrams showing a schematic of single-angle transducers on nominal and worn rail profiles, respectively.

FIG. 6 is a pictorial diagram showing a schematic of the rail profile beam 80 and its reflections 81-85 off of the membrane-rail interface.

FIG. 7 is a pictorial diagram showing the A-scan representation of rail profile beam at different locations along the secondary axis.

FIG. 8 is a pictorial diagram showing a two-dimensional rail wear angle (secondary axis versus height).

FIG. 9 is a flowchart of the process for adjusting the focal laws for the MPAs to compensate for rail wear.

### DETAILED DESCRIPTION OF THE INVENTION

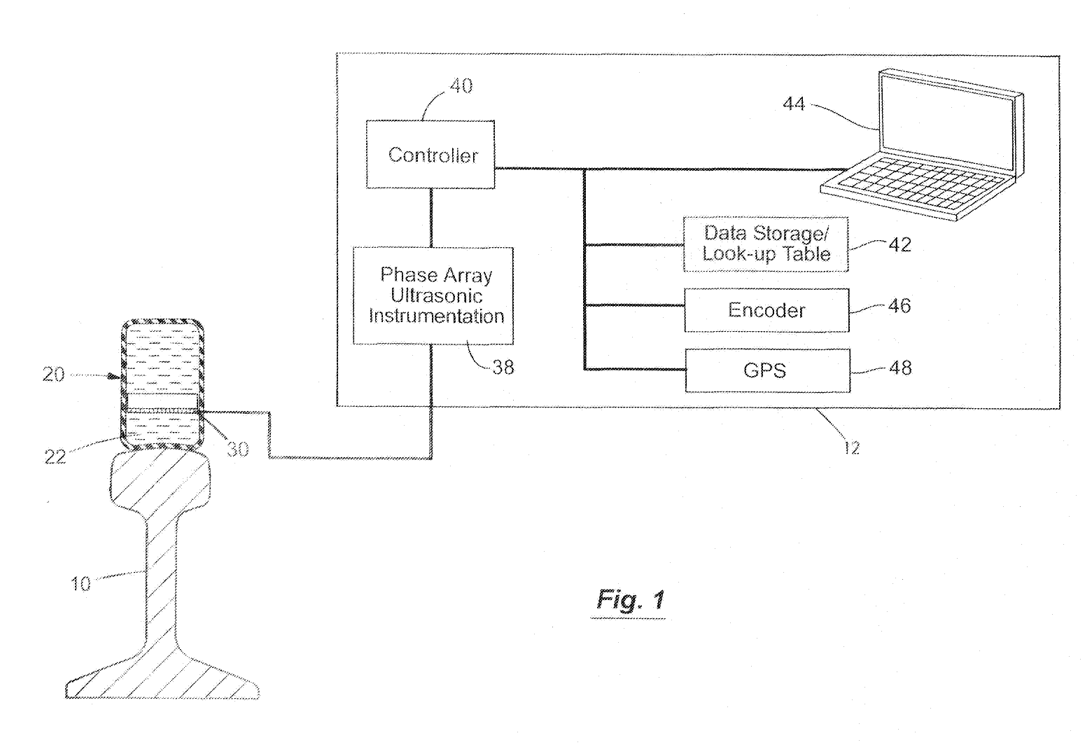

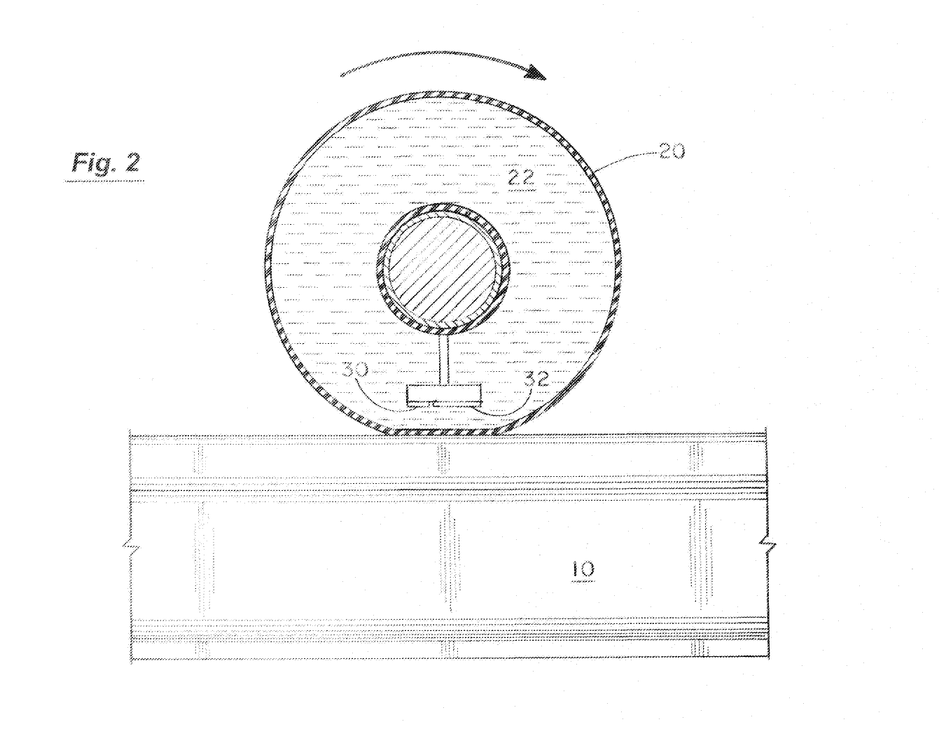

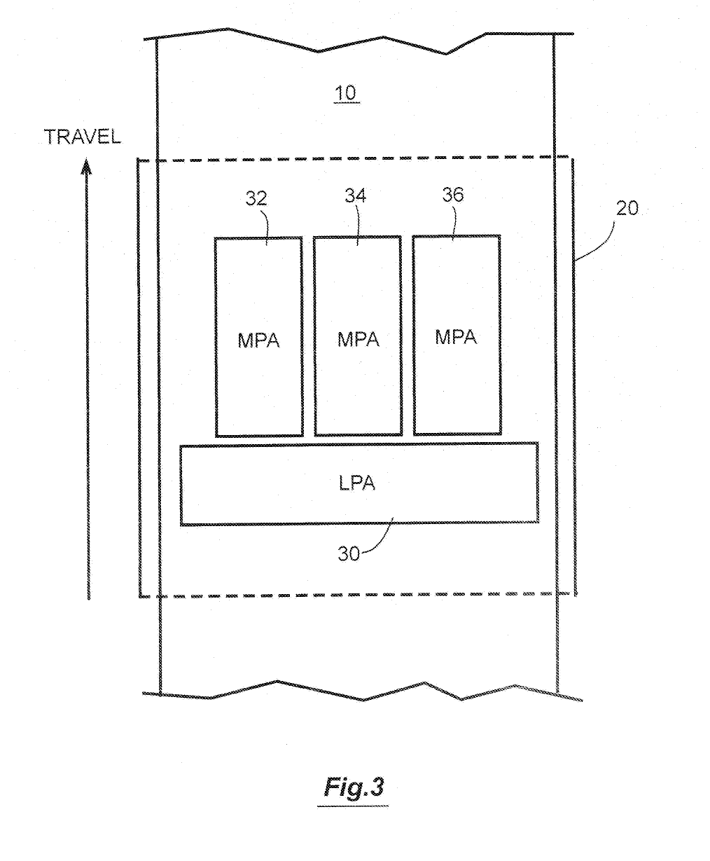

FIG. 1 is a simplified system block diagram of the present rail inspection system carried by a railway vehicle 12 to inspect a rail 10. The present ultrasonic rail inspection system is mounted on a suitable railway vehicle 12 to move along the rail 10 to be inspected. For example, a by-rail vehicle with a rear mounted carriage can be employed to carry the roller search unit (RSU) 20 containing a fluid 22. The test vehicle 12 and RSU 30 are used to guide a number of phased array ultrasonic probes 30-36 (shown in FIG. 3) along the rail 10. FIG. 2 is a cross-sectional side view of the rail 10 and RSU 20. The test vehicle 12 can also be equipped with a couplant spray system that applies a thin layer of liquid couplant onto the rail head prior to contact with the RSU 20.

Each phased array ultrasonic probe 30-36 is configured to scan an ultrasonic beam with a variable beam angle toward a section of a rail and receive an ultrasonic return signal from the rail. The phased array ultrasonic probes 30-36 can be operated in parallel to simultaneously inspect distinct regions of the rail.

This inspection system also includes a controller 40 (e.g., a computer processor) controlling operation of the phased array ultrasonic probes 30-36 via ultrasonic instrumentation hardware 38. The controller 40 is equipped with data storage that can include a database 42 for storing information on indications of rail defects and their locations found during the inspection process. For the purposes of this disclosure, it should be understood the term “controller” should be broadly construed to include any configuration of computer processors, control hardware/software, or ultrasonic instrumentation hardware.

The inspection system is also provided with a rail defect identification station for analysis of the ultrasonic return signals to identify indications of a potential rail defect. For example, this can be computer display 44 enabling an operator to view data generated by the controller from the return signals produced by the ultrasonic scans of the rail 10 and flag any indications of potential rail defects. Optionally, this process of identifying and flagging potential rail defects can be automated by a computer processor or other hardware to either supplement or replace visual inspection of the display 44 by a human operator.

The present rail inspection system can include an encoder 46, GPS receiver 48 or odometer for tracking the location of the test vehicle 12 during inspection, so that indications or potential rail defects or other areas of interest identified during initial inspection can be accurately identified and revisited for further inspection and repair.

Probe Configuration. Each phased array ultrasonic probe 30-36 is made up of multiple transducing elements built into an array (matrix, linear, annular, circular, etc.). These elements are pulsed in such a way to focus, scan, and steer the ultrasonic beam toward a desired region of the rail 10 with a desired beam angle. Each phased array probe can be programmatically configured by the controller 40 to produce variable beam angles. The probe configuration can be a combination of linear and matrix phased array probes 30-36 within an RSU 20 as shown in FIG. 3. In this embodiment, the linear phased array (LPA) 30 is oriented transverse to the rail section. The three matrix phased arrays (MPA) 32, 34 and 36 are arranged side by side with their primary axes parallel to the rail 10. The matrix phased array probes 32-36 lead in the direction of travel in this embodiment. A set of focal law inspection angles are optimized for 20 mph inspection by configuring the MPA probes 32-36 to inspect laterally +/−20 degrees and longitudinally +/−60 degrees. This results in about 80% of the rail head being inspected by the matrix probes. The center matrix probe 34 can also inspect the rail web all the way to the base of the rail 10. The outer flanges of the base section of the rail 10 are not inspected in this configuration.

In practice, the design and selection of phased array ultrasonic probes 30-36 should be done on a case-by-case basis as the phased array probe count, location, array design, element count, element size, etc., can be optimized for each application. For rail inspection, this optimization is performed between (1) coverage of inspection, (2) speed of inspection, and (3) equipment cost. Virtual modeling of various combinations of probe counts, locations, arrays, elements, etc., was performed and one result is the configuration shown in FIG. 3. The overall configuration consists of four phased array probes-three matrix phased array (MPA) probes 32, 34 and 36 and one linear phased array probe (LPA) 30. The MPA probes 32-36 ride at the front of the RSU 20 relative to the direction of travel and consist of 125 elements each in a 25×5 matrix. In this embodiment, the LPA probe 30 rides at the rear of the RSU 20 and consists of 54 individual elements in a row along the secondary axis transverse to the rail.

The element counts designed into the probes balance rail geometry, resolution, and instrument limitations. For the MPA probes 32-26, a total of 125 elements arranged in a 25×5 configuration were chosen in this embodiment to maximize the number of elements without exceeding a 128 channel maximum for the instrument hardware 38. A five-element count was selected for the secondary axis to provide some means of steering and focusing. This leaves 25 elements for the primary axis for each MPA probe 32-36. For example, the MPA probes 32-36 can have an element size of about 0.6×1.7 mm, and an element pitch of about 0.8 and 2.0 mm.

The LPA probe 30 can push the limit of the physical boundaries by employing 54 elements out of an allowable 64 channels for the instrument hardware 38. Any more elements might exceed the rail head width and the probe might be too long to fit within the RSU. For example, the LPA probe 30 can have an element size of about 0.8×10.0 mm, and an element pitch of about 1.0 mm.

Separating the total inspection elements into four probes 30-36 allows for speed enhancements as each probe can pulse, receive, and collect data simultaneously. In practice, each probe collects data as an independent unit. A key aspect of high-speed data collection is the serial nature of beam angle acquisitions. The instrument sequences, one-by-one, through each beam angle for every acquisition firing. This plays a role in limiting the maximum achievable inspection speed as each beam angle pulse-and-receive loop requires time to allow for the ultrasound energy to physically traverse into the rail, reflect, and travel back into the receiver. Each beam angle adds to overall cycle time for each acquisition. Separating these angles into disparate probes saves time because each probe only executes its own specific angles.

Beam Angles. Each of the phased array probes can be assigned its own inspection role and operates in parallel in inspecting different portions of the rail 10. For example, the matrix probes 32-36 can be dedicated to rail head inspection. The linear probe 30 can be dedicated to full rail height inspection through the web and side-looking inspection within the rail head.

Beam angles can be selected based on a combination of modeling and inspection simulation results, as well as experimental scans on rail samples containing known flaws. Preferably, the number of beam angles is minimized to provide faster inspection speeds (e.g., a goal of 20 mph inspection vehicle speed) while maintaining inspection fidelity. For example, a combination of beam angles can be selected to provide overlapping fields of view with inspection coverage of a large portion of the head area of the rail 10. Examples of the beam inspection angles are outlined below:

Center MPA nominal angle selections

| Primary Angle (°) | Secondary Angle (°) |
|---|---|
| 0 | 0 |
| 45 | 0 |
| −45 | 0 |
| 45 | 15 |
| 45 | −15 |
| −45 | 15 |
| −45 | −15 |

Field MPA nominal angle selections (Right Rail)

| Primary Angle (°) | Secondary Angle (°) |
|---|---|
| 45 | 0 |
| −45 | 0 |
| 45 | 15 |
| 45 | −15 |
| −45 | 15 |
| −45 | −15 |
| 60 | 20 |
| −60 | 20 |

Gage MPA nominal angle selections (Right Rail)

| Primary Angle (°) | Secondary Angle (°) |
|---|---|
| 45 | 0 |
| −45 | 0 |
| 45 | 15 |
| 45 | −15 |
| −45 | 15 |
| −45 | −15 |
| 60 | −20 |
| −60 | −20 |

LPA nominal angle selections

| Primary Angle (°) | Secondary Angle (°) |
|---|---|
| −48 | 0 |
| −34 | 0 |
| 34 | 0 |
| 48 | 0 |
| 0 | 0 |

For example, the beam angle set for the center MPA 34 can sweep between a primary angle of −45° to 45° in 2° increments with a secondary angle of 0°. Non-zero secondary angles are also possible.

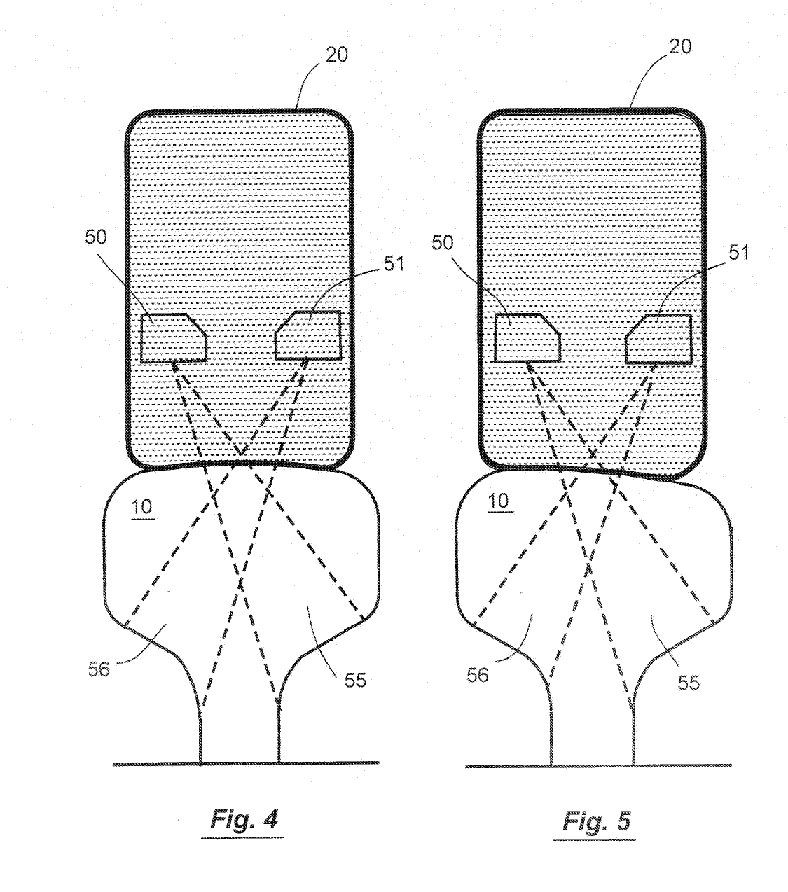

Rail Wear Detection. The present system dynamically compensates for wear in the rail profile during the inspection process. It is important to note that while the role of each phased array probe 30-36 remains constant throughout the rail inspection process, the actual refracted beam angles can vary depending on the degree of wear on the rails, as shown for example in FIGS. 4 and 5. The values listed in above tables outline the nominal values. If wear is detected, these values can shift to better cover the actual rail volume. The separation of probes provides an advantage in this case as each set of beam angles may be adjusted independently. For example, if wear is only detected on the gage side, adjustments may be limited to only the LPA and gage side MPA probes.

For example, the rail profile can be determined by using an array of ultrasonic probes (e.g., LPA 30 in FIG. 3) mounted transverse to the rail 10 to measure the distance between the ultrasonic transducer and the rail head (i.e., water-path distance for the ultrasonic signal within the RSU 20) at selected intervals spaced across the head of the rail 10. The time of flight of the ultrasonic signals at these locations provide an indication of distance. The measured distances at these locations are then used to determine the wear of the rail head, which can be approximated as a wear angle. Preferably, the wear compensation for each phased array probe is stored in a lookup table indexed by wear angle, so that the wear angle can subsequently be used to look up the appropriate focal law compensation during operation of the system. The focal law compensation is applied to the phased array focal law to direct each inspection beam according to the measured wear angle.

More specifically, developing an open-loop control system for maintaining consistent beam inspection path coverage requires a model for determining the appropriate beam angles to attain the desired coverage. The majority of this model is constant during an inspection scenario, such as the position of the probe, speed of sound through the RSU, speed of sound though the rail, sound refraction principles, etc. One set of noise factors in the model is the duration of sound travel within each medium (RSU liquid and rail surface). These durations are initially modeled with nominal rail dimensions, but in practice, the degree of wear on the rail can cause them to vary. Further, rail wear can lead to changes in the incident ultrasonic beam angle as it enters the rail. Changes in the incident beam angle will affect the path of the ultrasound through the rail and thus the effective coverage over defect-inducing zones. To properly control the beam inspection path over these zones, the degree of wear on each rail side must be known.

Conveniently, measurement of the rail surface contour can be obtained via a series of ultrasonic transducers extending at intervals across the rail head (i.e., along the secondary axis of the rail). The time-of-flight data from these ultrasonic transducers can be used in real time to determine the rail wear. The membrane of the RUS conforms to the rail head surface and represents the contour of the running surface. Time of flight values vary as the water path distance changes across the rail head. Consequently, time of flight data is used to dynamically control the beam angle of the phased arrays within the rail material. This corrects the inspection path by compensating for variations in the rail profile.

More specifically, rail profile wear compensation can be accomplished by approximating the change in rail profile with a wear angle for each phased array, and then applying corrected focal laws based on this wear angle for each phased array. The process can be explained as follows. The phased array probe is excited and the time of flight of the ultrasonic signals to/from the head of the rail is measured at a plurality of locations across the rail head. Although the combined effect of elements in the phased array is to produce a beam that can be steered by the controller, each ultrasonic probe element fires downward toward the rail and the time of flight for the vertical wave front can be measured for each ultrasonic probe element. The time of flight at each location across the rail head is used to determine the distance between each ultrasonic probe element and the head of the rail, which can be combined to determine the contour of the head of the rail.

In the preferred embodiment of the present invention shown in the accompanying drawings, the ultrasonic transducers 30-36 are located in a water-filled RSU 20. The thickness of the RSU membrane can be assumed to be substantially constant across the rail head. In this embodiment, the time of flight to/from the membrane rail interface is measured. Here, the time of flight represents the water path distance between each ultrasonic probe element and the membrane rail interface, because the water path distance is physically determined by the contour of the head of the rail. Regression applied to the water path distance values returns the wear angle value. Wear angles are indexed over the expected range of wear angle values and stored in a look-up table for future retrieval by the controller 40. During rail inspection, the appropriate focal law is applied based on which index the measured angle falls within. In the preferred embodiment, focal laws that compensate for each indexed wear angle are stored in a lookup table for immediate recall when queried. Filtering and smoothing can be used to stabilize the selection process. This feature should be designed and implemented to allow real-time modification of the focal laws without interrupting or significantly slowing data collection. Alternatively, other shapes or curves could be used to approximate the rail head profile.

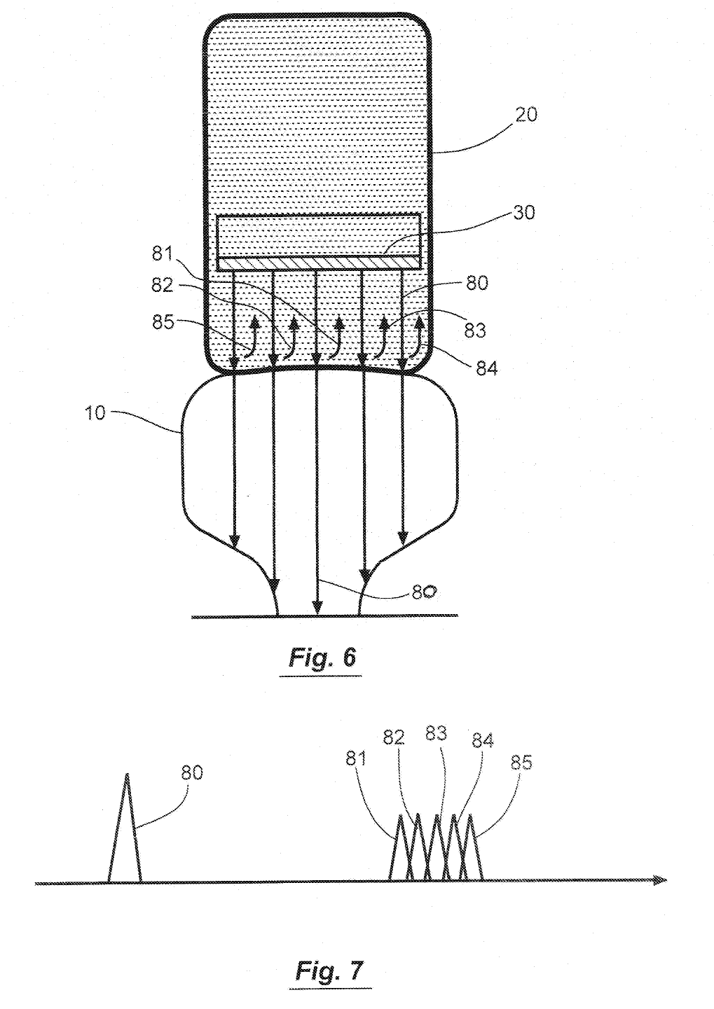

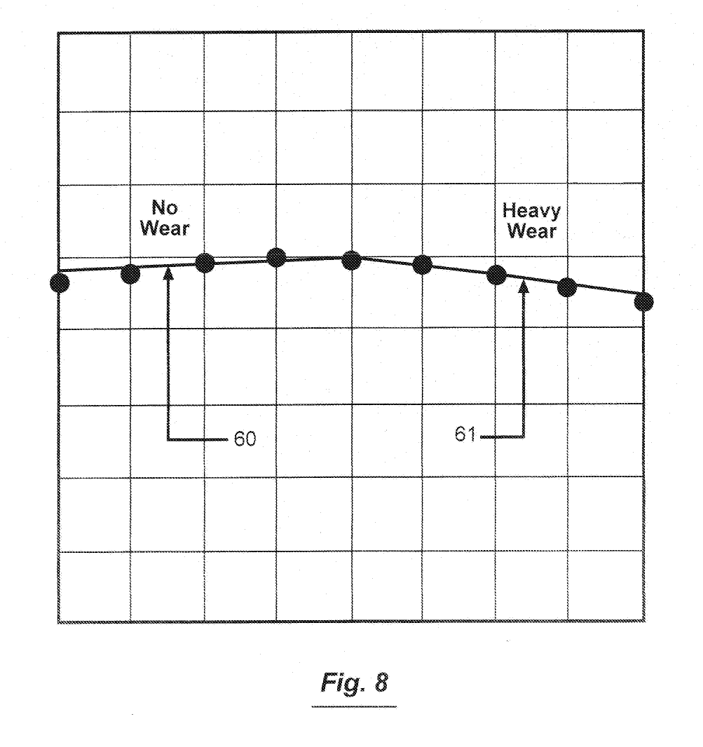

Three beam angles inspecting distinct zones across the secondary axis of the rail are preferable. Ideally, more angles can be spaced along the secondary axis to provide a better-defined profile. Fewer angles can be used but will result in a less well defined profile. For each beam 80, the ultrasound is pulsed at the probe, travels through the RSU liquid 22, through the RSU membrane and into the rail 10 as shown in FIG. 6. It is the interface between the RSU membrane and the rail 10 which is important for profiling. As the ultrasound arrives at the membrane-rail interface some ultrasound 81-85 will reflect back to the probe and some will transmit through the rail. The reflected ultrasound will manifest itself as a peak in the A-scan signal. The distance at which this peak is measured is what draws the rail profile. The greater the distance, the greater the rail wear. FIG. 7 illustrates typical A-scan results from a set of rail profile beams 80 at different locations along the secondary axis. The beams that are closer to the center of the rail will have a membrane-rail interface peak closer to the probe. The reflected beams 81-85 that are offset from the rail head centerline toward the gauge or field side will have a membrane-rail interface peak farther from the probe.

The sound path position value of each membrane-rail interface peak is then plotted as a function of secondary axis position. The result is a two-dimensional profile of the rail head, as illustrated in FIG. 8. Using these points, an equation of a line 60, 61 is then calculated for each side of the rail. The geometric slope from this line 60, 61 determines the wear angle for each side of the rail. It is this angle which is then used as a means of feedback for the beam inspection path control loop.

The embodiment shown in FIGS. 3 and 6 employs a linear phased array (LPA) ultrasonic probe 30 to determine the rail wear contour, although it should be understood that a profile estimation can be accomplished with any array of ultrasonic elements including a simple array of ultrasonic transducers extending laterally across the rail head, or even elements from other phased array transducers. Although the embodiment of the present invention shown in FIG. 3 shows three matrix phased arrays 32-36 and one linear phased array 30, it should be understood that the number, configuration and shape of the rail inspection phased array ultrasonic transducers is a matter of engineering design and that wear angles can be estimated with as few as two suitably spaced elements

Beam Control. As discussed above, an open-loop control system can be utilized to maintain proper beam inspection coverage over a targeted defect-prone zone. This system relies heavily on sound wave propagation principles and known values such as the starting position of the ultrasound beam, the angle of the beam, and speed of sound through the propagation materials (RSU liquid 22 and rail material). The main source of noise to the control loop is wear along the rail profile. This wear angle has an effect on the time duration ratio between the RSU liquid and the rail surface. This ratio, in turn, has an effect on how the ultrasound beam refracts along the sound path. If the system model does not include the wear angle, the resultant beam refraction can shift the ultrasound beam out of the targeted defect-prone zone.

The wear angle can be included in the system model by using a lookup table linking wear angle to the programmed beam angle. For example, given a beam angle for targeting a defect-prone zone, the lookup table defines the proper adjusted beam angles to compensate for measured wear angle. The following is an example of a lookup table for one beam angle:

Lookup Table

| Wear Angle (°) | Beam Angle (°) |
|---|---|
| 2.5 | 44.6 |
| 5.0 | 45.0 |
| 7.5 | 45.4 |
| 10.0 | 45.8 |
| 12.5 | 46.2 |
| 15.0 | 46.6 |
| 17.5 | 47.0 |
| 20.0 | 47.4 |

In theory, the wear angle can be included in the overall model for calculating the proper beam angle to target a defect-prone zone. However, this is a processor-intensive calculation taking time to compute. For rail inspection, this time may not be available as it can slow down inspection speed. Therefore, these calculations are preferably performed prior to inspection for a range of expected wear angles and the computed beam-angle-to-wear-angle relationships are stored in a lookup table for quick retrieval.

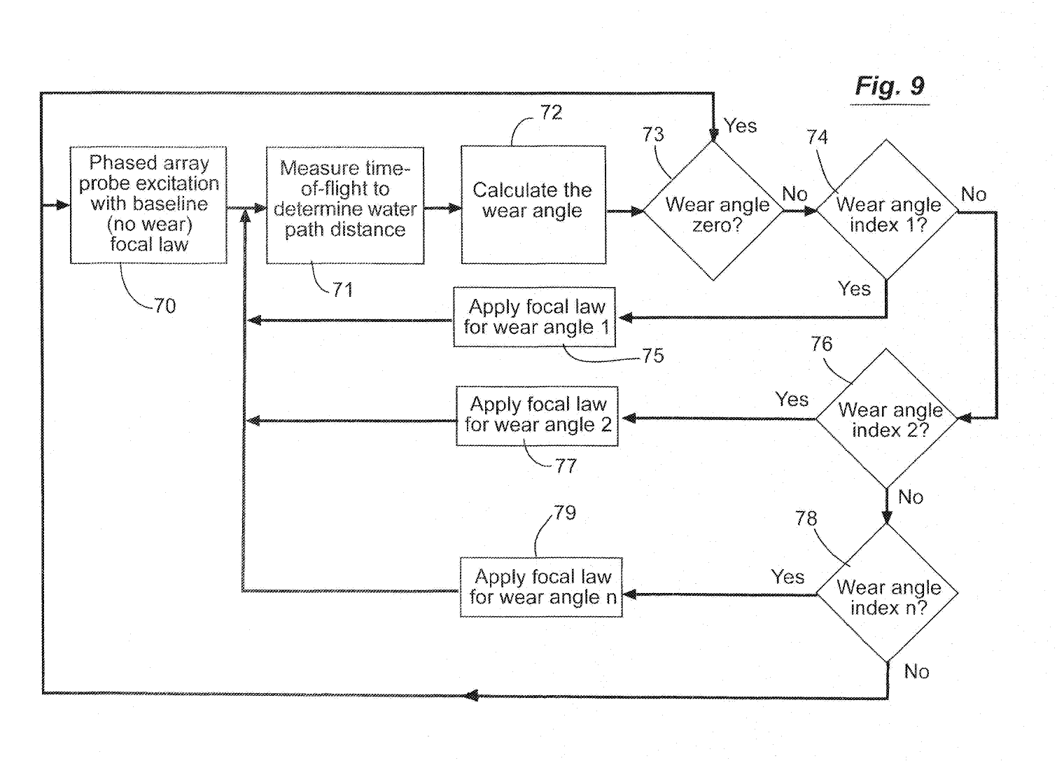

FIG. 9 is a flowchart of the process for adjusting the focal laws to compensate for rail wear. Using this technique, a measurement of wear angle can be taken continuously throughout the inspection and as the angle shifts from one level to the next, the beam angle is automatically adjusted to maintain constant coverage over the targeted defect-prone zone. In particular, the flowchart in FIG. 9 is initiated at step 70 by the controller/processor 40 retrieving the baseline focal law for each phased array probe 30-36 associated with no rail wear. The controller 40 then uses the ultrasonic transducers 30 to measure the time-of-flight to determine the water path distance through the RSU 20 to the rail head (step 71). The controller 40 can then determine the wear angle for each side of the rail 10 (step 72).

The entire range of possible wear angles can be divided in “n” consecutive ranges for the purpose of storing and rapidly retrieving the adjusted focal laws in a lookup table. If the wear angle is zero (step 73), the baseline focal laws are employed for exciting the phased array ultrasonic probes 30-36. If not, the controller 40 progressively steps through the limits for these ranges (1 through n) in steps 74, 76, 78 to determine which range the calculated wear angle falls within, and then retrieves and applies the corresponding adjusted focal laws (steps 75, 77, 79) from the lookup table. This process is then repeated for each iteration of the inspection process.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. An ultrasonic inspection system for railway rails comprising:
a railway vehicle for moving along the rails;
at least one phased array of ultrasonic transducers on the vehicle having ultrasonic transducers extending transverse to the head of a rail to be inspected, said phased array configured to controllably scan an ultrasonic beam with a variable beam angle toward a section of the rail determined by its focal law and receive ultrasonic return signals from the rail;
a controller determining the wear profile of the rail from return signals received by the phased array, and adjusting the focal laws for the phased array based on the rail wear profile as the vehicle moves along the rails; and
a rail defect identification station for identifying defects in the rail based on the ultrasonic return signal from the rail received by the phased array.

2. The ultrasonic inspection system of claim 1 wherein the wear profile is determined by measuring the time of flight of the ultrasonic beams and return signals at locations across the head of the rail.

3. The ultrasonic inspection system of claim 1 wherein the wear profile of the section of the rail for each phased array is approximated as a wear angle.

4. The ultrasonic inspection system of claim 1 further comprising a look-up table accessible by the controller containing adjustments to the focal laws of the phased array as a function of the wear profile.

5. The ultrasonic inspection system of claim 1 further comprising a rolling search unit for rolling along the rail with the phased array mounted within the rolling search unit.

6. An ultrasonic inspection system for railway rails comprising:
a railway vehicle for moving along the rails;
a rolling search unit mounted to the vehicle for rolling along a rail to be inspected;
a linear phased array ultrasonic probe mounted within the rolling search unit and extending transverse to the head of the rail to be inspected, said phased array configured to controllably scan an ultrasonic beam across the head of the rail determined by its focal law and receive ultrasonic return signals from the rail;
at least one matrix phased array ultrasonic probe mounted within the rolling search unit, each matrix phased array configured to controllably scan an ultrasonic beam with a variable beam angle toward a section of the rail determined by its focal law and receive an ultrasonic return signal from the rail;
a controller determining the wear profile of the rail from return signals received by the linear phased array, and adjusting the focal laws for the phased arrays based on the wear profile as the vehicle moves along the rails; and
a rail defect identification station for identifying defects in the rail based on the ultrasonic return signals from the rail received by the phased arrays.

7. The ultrasonic inspection system of claim 6 wherein the wear profile is determined by measuring the time of flight of the ultrasonic beams and return signals at locations across the head of the rail.

8. The ultrasonic inspection system of claim 6 wherein the wear profile of the section of the rail for each phased array is approximated as a wear angle.

9. The ultrasonic inspection system of claim 6 further comprising a look-up table accessible by the controller containing adjustments to the focal laws of the phased arrays as a function of the wear profile.

10. An ultrasonic inspection system for railway rails comprising:
a railway vehicle for moving along the rails;
a plurality of phased arrays of ultrasonic transducers on the vehicle and having ultrasonic transducers extending transverse to the head of a rail to be inspected, each phased array configured to controllably scan an ultrasonic beam with a variable beam angle toward a section of the rail determined by its focal law and receive ultrasonic return signals from the rail;
a controller determining the wear angle of the section of the rail for each phased array from return signals received by the phased arrays, with a look-up table containing adjustments to the focal laws of the phased arrays as a function of the wear angle, wherein the controller adjusts the focal law for each phased array based on the wear angle for the section of the rail for each phased array as the vehicle moves along the rails; and
a rail defect identification station for identifying defects in the rail based on the ultrasonic return signals from the rail received by the rail inspection phased array.

11. The ultrasonic inspection system of claim 10 wherein the wear angle is determined by measuring the time of flight of the ultrasonic beams and return signals at locations across the head of the rail.

12. The ultrasonic inspection system of claim 10 further comprising a rolling search unit for rolling along the rail, with the phased arrays mounted within the rolling search unit.
